(19) United States
(12) Patent Application Publication
(10) Pub. No.: US 2020/0199910 A1
(43) Pub. Date: Jun. 25, 2020

(54) ELECTRONIC DOOR LOCKING SYSTEM AND METHOD OF USE

(71) Applicant: Faiz Khan, San Jose, CA (US)

(72) Inventor: Faiz Khan, San Jose, CA (US)

(21) Appl. No.: 16/227,118

(22) Filed: Dec. 20, 2018

Related U.S. Application Data
(60) Provisional application No. 62/782,486, filed on Dec. 20, 2018.

(51) Int. Cl. E05B 47/00; G07C 9/00

(52) U.S. Cl. CPC E05B 47/0012; G07C 9/00182; G07C 2009/0019; E05B 2047/0095; E05B 2047/0091

(57) ABSTRACT

An electronic lock system includes a door having a locking bolt controlled via a knob; an electronic control device to engage with the mechanical device, the electronic control device having a housing with an exterior surface and forming an interior area; a control system housed within the interior area, the control system having a wireless chip and a motor; a grip engaged with the motor via a shaft, the grip extending to an exterior area of the housing; a securing device to secure the housing to the door; a mobile electronic device to wirelessly communicate with the control system; the grip is to removably attach to the knob; the mobile electronic device is to transmit a command to the control system to activate the motor such that the mechanical device is turned via the grip.

### BACKGROUND

### 1. Field of the Invention

The present invention relates generally to door locking systems, and more specifically, to a system and device for securing to an already installed door lock to retrofit the door lock to an electronic locking system, thereby allowing for user control via a phone or other mobile electronic device.

### 2. Description of Related Art

Door locking systems are well known in the art and are effective means to lock up a household or business. For example, FIG. 1 depicts a conventional system 101 having a door 103 with a front side 105, a handle/door knob 107, a locking knob 109, and a bolt 111. The door is secured in a frame 113 and locked to prevent entry. In FIGS. 2A and 2B, one style of a conventional door lock 201 is shown, having a door knob 203 with a locking knob 207 engaged with a bolt 209 such that rotation of the knob 207 forces the bolt 209 from a lock housing 211 to thereby lock the door. It should be understood that there are many variations of locks in which a knob is turned, pushed down, pulled up, or the like to engage the lock and lock the door.

One of the problems commonly associated with system 101 is limited use. For example, it is desirable to have an electronic lock in which the user can share electronic keys and utilize a mobile electronic device to unlock the electronic lock. However, installing a completely new lock, or replacing parts of a lock to create an electronic locking system can be expensive and difficult. This conventional practice requires replacing entire portions of a door knob, lock, or the like.

Accordingly, it is an object of the present invention to provide a device that can be secured to a conventional door knob/deadbolt/key or other mechanical locking device in which the user can then use a mobile device for locking and unlocking the conventional door lock without replacing any piece of the conventional system. It must be understood that the present invention is designed for use with locks and door knobs already installed, thereby eliminating the need for the user to install completely new locks or replace components of an existing system.

Accordingly, although great strides have been made in the area of door locking systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric view of a common door locking system;

FIGS. 2A and 2B are front views of a common door lock;

FIG. 3 is a side view of an electronic door locking system in accordance with a preferred embodiment of the present application;

FIG. 4 is a schematic of the system of FIG. 3;

FIG. 5 is an end view of a first embodiment of a grip of FIG. 3;

FIG. 6 is a side view of a second embodiment of a grip of FIG. 3;

FIG. 7 is a side view of an alternative embodiment of an electronic door locking system in accordance with the present application; and

FIG. 8 is a flowchart of a method of use of the system of FIG. 3.

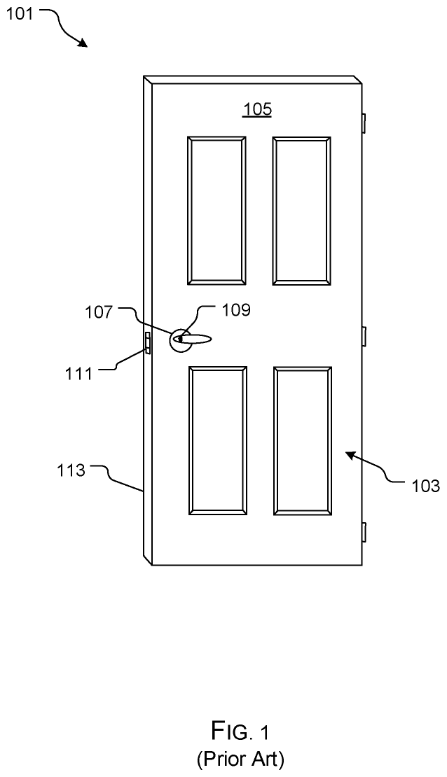

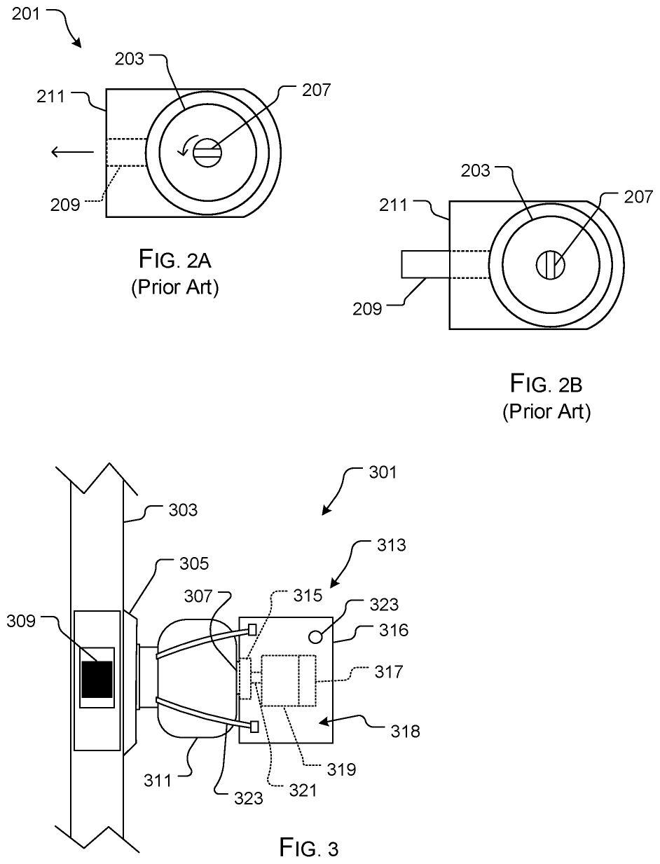

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional door locking systems. Specifically, the present invention provides for an electronic device that can be installed in connection with a conventional door lock, including various forms of conventional door locks, and provides a means for electronically and wirelessly locking and unlocking. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

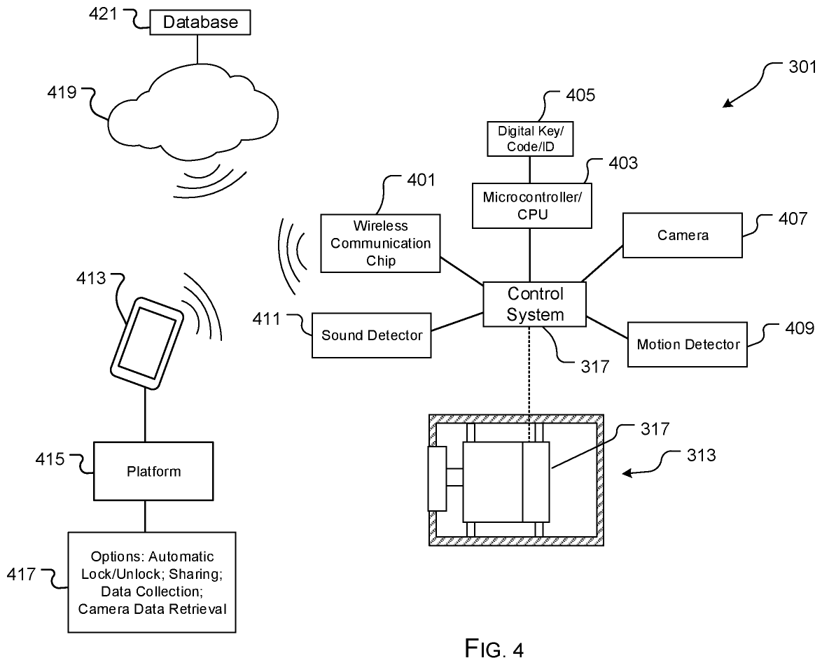

Referring now to the drawings wherein like reference characters identify corresponding or similar elements throughout the several views, FIG. 3 depicts a side view of an electronic locking system 301 in accordance with a preferred embodiment of the present application. It will be appreciated that system 301 overcomes one or more of the above-listed problems commonly associated with conventional door locking systems.

In the contemplated embodiment, system 301 includes a door 303 having a lock 305 with a locking knob 307 engaged with a bolt 309. In this embodiment, a round door knob 311 is shown, however, it must be understood that the system of the present invention is adaptable for use with deadbolts, elongated door handles, or other types and styles of mechanical door locks. In addition, the system can be adapted and utilized with a key, wherein the device engages directly with the key.

System 301 includes an electronic locking device 313 configured to be secured such that the electronic locking device 313 engages with knob 307 via a grip 315. It should be appreciated that the grip 315 can vary in form and function so long as the grip is able to securely attach to the knob. Electronic locking device 313 further includes a housing 316 with an interior area 318 housing a control system 317 in communication with a motor 319, wherein the motor 319 is engaged with the grip 315 via a shaft 321 or the like. In some embodiments, a camera, motion detector, or sound detector 323 is further secured to housing 316 and in communication with control system 317.

It should be appreciated that one of the unique features believed characteristic of the present application is the configuration of device 313 that allows for device 313 to be engaged with a conventional lock, thereby allowing for a user to utilize their conventional locks with electronic, wireless control.

Electronic device 313 further includes one or more securing devices to secure the device to the door or door knob. As shown in FIG. 3, one contemplated securing device is one or more straps 323 which can be flexible and/or elastic, thereby allowing for the straps to secure around the door knob 311 and secure the housing in place. It should be appreciated that any number of means for securing the housing to the door knob/door could be utilized.

In FIG. 4, a simplified schematic further depicts the features of system 301. System 301 including the electronic device 313 with control system 317. Control system 317 can include a wireless chip 401, which can be a Bluetooth enabled chip and/or a wifi enabled chip. The control system 317 further including some form of computing chip, such as a microcontroller or CPU 403, this allows for the control system to receive an activate commands. The control system 317 is further configured with a unique digital key/code/ID 405 which allows for the user to control the device and share the digital key with other individuals.

In some embodiments, additional features such as a camera 407, a motion detector 409, and a sound detector 411, can be implemented and in communication with the control system.

System 301 further includes a mobile electronic device 413 with a mobile platform 415 through which the user can send commands, receive data, and select options 417. Some options contemplated are allowing the user to share a key with another individual, allowing the user to establish parameters in which the electronic locking device automatically locks or unlocks, such as when the user enters a predetermined range with the mobile device, and further the platform can be configured to receive data from the electronic locking device.

System 301 can further include a cloud based network 419 with a database 421 for data collection and facilitation of communication between the mobile device 413 and the control system 317.

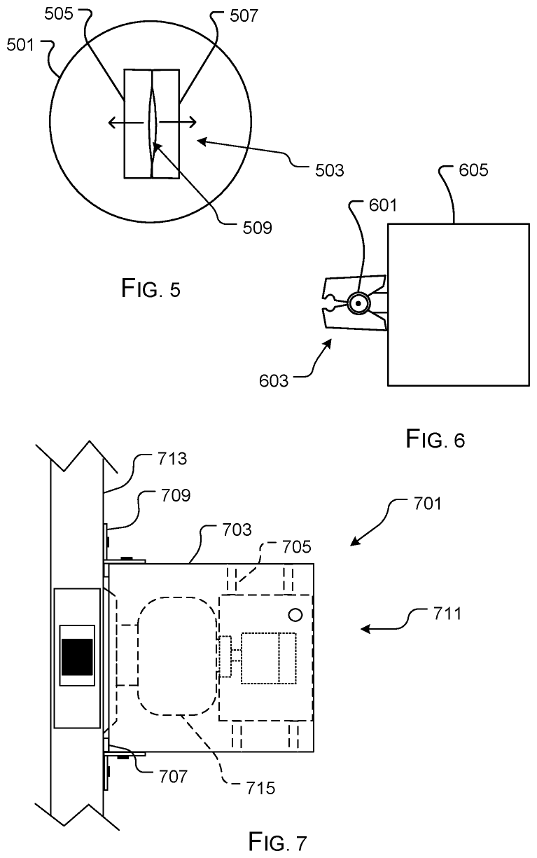

In FIGS. 5 and 6, two contemplated embodiments for a grip are shown. In FIG. 5, an end view is shown, having a round shaped housing 501 and a grip 503 formed by two flexible rods 505, 507 forming an opening 509 in which the knob is inserted and retained via friction and pressure. The rods 505, 507 can be composed of rubber, plastic, silicone, or the like. In FIG. 6, a side view depicts a spring 601 loaded grip 603 extended from housing 605 in which the grip is configured to clamp down on the knob to secure the two together. Again, it should be appreciated that any variation of grip could be utilized.

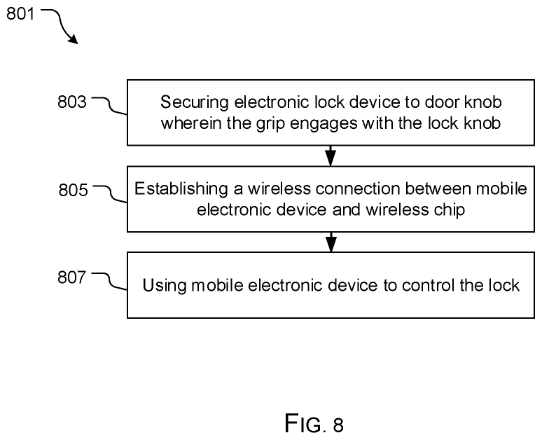

In FIG. 7, a side view of an alternative embodiment of an electronic locking system 701. It should be understood that the features of this embodiment are interchangeable with the features of the other embodiments. System 701 includes all of the features discussed above, but further includes an exterior housing 703 in which the other components can be mounted via mounts 705. Exterior housing 703 can include an adhesive 707 and/or one or more brackets 709 to secure the electronic locking device 711 to the door 713. It should be appreciated that the exterior housing 703 can secure entirely around knob 715.

It should be appreciated that the housings can vary in materials, shape, and style as aesthetical, functional, or manufacturing considerations require.

In FIG. 8, a flowchart 801 depicts a method of use of the systems discussed herein. During use, the user will install the electronic lock device to a door such that the grip engages with the lock knob, as shown with box 803. As previously discussed, the electronic lock device can engage in any number of ways, including straps, brackets, adhesives, or any other means. The user then establishes a wireless connection between the electronic locking device and a mobile device, such as a mobile phone, as shown with box 805. The user can then proceed to electronically lock and unlock the door, as shown with box 807.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. An electronic lock system, comprising:
a door having a locking bolt controlled via a mechanical device;
an electronic control device configured to engage with the mechanical device, the electronic control device having:
a housing with an exterior surface and forming an interior area;
a control system housed within the interior area, the control system having a wireless chip and a motor;
a grip engaged with the motor via a shaft, the grip extending to an exterior area of the housing;
a securing device configured to secure the housing to the door;
a mobile electronic device configured to wirelessly communicate with the control system;
wherein the grip is configured to removably attach to the mechanical device; wherein the mechanical device is one of a knob or key; and
wherein the mobile electronic device is configured to transmit a command to the control system to activate the motor such that the mechanical device is turned via the grip.

2. The system of claim 1, wherein the mobile electronic device further includes a mobile application configured to be manipulated by a user.

3. The system of claim 1, wherein the control system further includes a CPU.

4. The system of claim 1, further comprising:
a database in wireless communication with the control system and configured to receive and record data.

5. The system of claim 1, wherein the electronic control device further comprises:
a camera secured to the exterior surface and in communication with the control system.

6. The system of claim 1, wherein the wireless chip is Bluetooth enabled.

7. The system of claim 1, wherein the wireless chip is wifi enabled.

8. The system of claim 1, wherein the securing device is a brace configured to be secured directly to the door.

9. The system of claim 1, wherein the securing device is an adhesive.

10. The system of claim 2, wherein the securing device is a strap.

11. A device, comprising:
a housing with an exterior surface and forming an interior area;
a control system housed within the interior area, the control system having:
a wireless chip and a motor;
a grip engaged with the motor via a shaft, the grip extending to an exterior area of the housing;
a securing device configured to secure the housing to the door;
a mobile electronic device configured to wirelessly communicate with the control system;
wherein the grip is configured to removably attach to a mechanical device;
wherein the mechanical device is one of a knob or key; and
wherein the mobile electronic device is configured to transmit a command to the control system to activate the motor such that the mechanical device is turned via the grip.
